(19) United States
(12) Patent Application Publication
(10) Pub. No.: US 2005/0044207 A1
(43) Pub. Date: Feb. 24, 2005

(54) Service processor-based system discovery and configuration

(75) Inventors: Kenneth S. Goss, Austin, TX (US); Karl Rasmussen, Temple, TX (US)

Correspondence Address: Raymond M. Galasso;Simon, Galasso & Frantz PLC, P.O. Box 26503, Austin, TX, 78755-0503, US

(73) Assignee: Newisys, Inc.

(21) Appl. No.: 10/628,280

(22) Filed: Jul. 28, 2003

(51) Int. Cl. G06F 15/173

(52) U.S. Cl. 709/224

(57) ABSTRACT

One embodiment of the disclosures made herein is a method for facilitating service processor-based system discovery and configuration. In accordance with such an embodiment, an operation is performed for tracking status information of a system component of a platform-side operating system in a data processing system. A service processor of the data processing system facilitates tracking the status information. Probing a device driver associated with the system component and receiving corresponding status information from the device driver is an example of facilitating tracking of the status information. In response to and/or in conjunction with tracking status information, an operation is performed by the service processor for enabling access of at least a portion of said status information the platform firmware. The platform firmware facilitates an operation for configuring the platform-side operating system dependent at least partially upon said status information in response to accessing at least a portion of the status information.

### FIELD OF THE DISCLOSURE

The disclosures made herein relate generally to data processing systems and more particularly to service processor-based system discovery and configuration.

### BACKGROUND

Information and the means to exchange information via computing technology have grown to be sophisticated and complex compared to the state of the art a mere 15 years ago. Today, data processing systems (e.g., servers) have become critical to the efficient function and conduct of business in numerous sectors worldwide, ranging from governments to corporations and small businesses. The increasingly critical role of computing assets has, in turn, been the basis for concern from various sectors as to the reliability and manageability of computing assets.

System downtime events associated with system component (e.g., hardware, firmware and software) problems result in considerable expense to businesses in the retail and securities industries, among others. Moreover, with networked applications taking on more essential business roles daily, the cost of system downtime will continue to grow.

Another significant cost of system downtime is related to diagnosing and repairing a system component problem. Many systems offer only minimal diagnostic functions, and these generally only to the level of whether or not the system is running. System firmware (e.g., Basic Input output System (BOIS), Extensible Firmware Interface (EFI), etc), which does discovery at boot time, and embedded diagnostic codes such as power-on self test (POST) are examples of conventional approaches for performing discovery and configuration tasks in a data processing system. Such conventional approaches for performing discovery and configuration of a data processing system carry out limited diagnostic tests automatically when a computer is powered up.

It is typical for a POST series of diagnostic tests performed by a particular data processing system to vary, depending on the BIOS configuration. But, POST typically tests only system components such as RAM (Random Access Memory), physical I/O devices and, and access to disk drives. If the tests are successful, POST initiates loading of the operating system and the system boots. Otherwise, the fault area is reported/isolated for analysis. However, because POST executes its diagnostic functions only upon power-up, it is not capable of diagnostic monitoring during normal system operations.

Systems that are dependent upon BIOS or EFI discovery cannot track error conditions. Accordingly, they cannot modify boot configurations in response to transient or historical errors. If a particular system component passes a boot-time test at discovery, it is assumed to be good for use in the system. However, because the firmware (e.g., BIOS or EFI) is not aware of the history of that particular component (e.g., if the component had contributed to the failure of the OS on a previous boot), actions such as issuing a warning notification and/or removing a failing, failed or questionable component cannot be implemented prior to boot-time.

Furthermore, systems dependent upon BIOS or EFI discovery do not track the status of redundant system components (e.g., a redundant path to a particular input-output device) over time. This precludes redundant system components from being used unless the primary component fails the boot-time test and precludes the system from issuing notification as to the availability of such redundant system components. Another limitation is that systems dependent upon BIOS or EFI discovery perform only the same tests on primary and redundant components. Thus, a redundant component that is showing only transient problems could be placed in the system if it survived the boot-time test.

With respect to configuring a data processing system, a system dependent upon firmware-based discovery approaches facilitates discovery of system components via the firmware during boot-time (e.g., through hardware detection, Advanced Configuration and Power Interface (ACPI) tables, etc). The firmware then configures the system based on this information. A limitation to such an approach is that discovery information is not based on the historical information of the system components, but instead on component availability or customer configuration.

Therefore, methods and equipment adapted for facilitating discover and/or configuration of a data processing system in a manner that overcomes limitations associated with conventional approaches for facilitating discover and/or configuration would be useful.

### BRIEF DESCRIPTION OF THE DRAWING FIGURES

FIG. 1 depicts a data processing system in accordance with an embodiment of the disclosures made herein.

FIG. 2 depicts a method in accordance with an embodiment of the disclosures made herein, wherein the method is configured for facilitating discovery of system configuration information and facilitating configuration of a platform operating system using at least a portion of discovered system configuration information.

FIG. 3 depicts an embodiment of the operation for facilitating management of primary system components depicted in FIG. 2.

FIG. 4 depicts an embodiment of the operation for facilitating management of redundant system components depicted in FIG. 2.

### DETAILED DESCRIPTION OF THE DRAWING FIGURES

The disclosures made herein relate to service processor-based system discovery and configuration. Methods and equipment in accordance with embodiments of the disclosures made herein are adapted for facilitating such service processor-based discovery and configuration. Managing system components in a data processing system includes facilitating discovery and configuration.

The following definitions are not intended to be limiting, but are provided to aid the reader in properly interpreting the detailed description of the present invention. It will be appreciated that the terms defined herein may be eventually interpreted by a judge or jury, and that the exact meaning of the defined terms will evolve over time. The phrase “device drivers,” as used herein and sometimes referred to as service modules, refers to images that provide service to other modules in memory. A driver can “expose a public interface,” that is, make available languages and/or codes that applications use to communicate with each other and with hardware. Examples of exposed interfaces include an ASPI (application specific program interface), a private interface, e.g., a vendor's flash utility, or a test module protocol for the diagnostic platform to utilize. The word “platform” as used herein generally refers to the server functionality provided by the underlying hardware. Such functionality may be provided using single integrated circuits, for example, various information processing units such as central processing units used in various information handling systems. Alternatively, a platform may refer to a collection of integrated circuits on a printed circuit board, a stand-alone information handling system, or other similar devices providing the necessary functionality. The term platform also describes the type of hardware standard around which a computer system is developed. In its broadest sense, the term platform encompasses processors, and other integrated circuits that provide initialization, diagnostic, and server functionality. The word “server” as used herein refers to the entire product embodied by the present disclosure, typically a service processor (SP) and one or more processors. In an embodiment, the one or more processors are AMD K8/Opteron processors, or other processors with performance characteristics meeting or exceeding that of AMD K8/Opteron processors.

One embodiment of a data processing system as disclosed herein is a server that includes components for providing server operating system functionality on a platform side of the data processing system (i.e., a platform-side operating system) and components for providing service processor functionality on a service side of the data processing system (i.e., a service processor). The service processor provides functionality such as remote management, diagnostics, discovery and/or monitoring support of the platform-side operating system portion of the data processing system.

A platform of such a disclosed data processing system (e.g., server platform) includes firmware (i.e., platform firmware) that is passed status information of one or more components of the platform-side operating system (i.e., system components). The status information is discovered and analyzed by the service processor prior to boot of the platform-side operating system. As discussed below in greater detail, the service processor is advantageously adapted for enabling the service processor to track the history of such one or more components and to analyze the remains of a previous operating system instantiation. In response to such tracking and analyzing, the service processor may make a determination of whether a component should be included as a primary component in the next boot of the platform-side operating system. Accordingly, the service processor can interact with the user prior to the boot to warn about failing components or can automatically remove suspect components (based on customer preference) and the system may be configured at least partially dependent upon the status information passed to the platform firmware.

An embodiment of a data processing system as disclosed herein offers a number of advantages over conventional data processing systems. One advantage is allowing complicated configuration information to be specified by a user in a rich service processor-based user interface. Another advantage is allowing for error detection and tracking with persistent information, which permits configuration changes to be implement that are intended to repair or relieve historical and transient error conditions. Yet another advantage is allowing for monitoring of redundant components and notifying a system administrator or other authorized party of a particular component's ability to respond to error conditions.

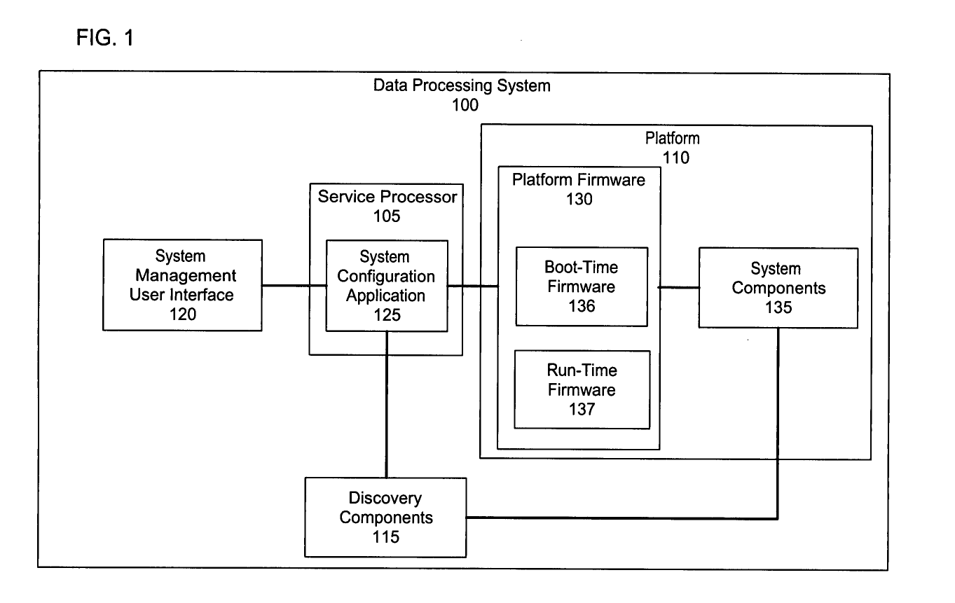

Turning now to discussion of specific drawings, a data processing system 100 in accordance with an embodiment of the disclosures made herein is depicted in FIG. 1. The data processing system 100 includes a service processor 105, a platform 110, discovery components 115 and a system management user interface 120. The service processor 105 includes a system configuration application 125 running thereon. In other embodiments of the data processing system 100 (not shown), the discover components 115 and the system management user interface 120 may be components of the service processor 105. The system configuration application 125 is configured for enabling functionality such as system component discovery, system component analysis and platform operating system configuration to be carried out.

The platform 110 includes platform firmware 130 and a plurality of system components 135. Examples of the system components 135 include processors, memory DIMMs, coherency controllers (e.g., Horuses, which is a custom memory bus controller), Hyper-Transport paths and the like. The platform firmware 130 includes boot-time firmware 136 and run-time firmware 137. The system components 135 and the run-time firmware 137 are elements of a platform-side operating system. The boot-time firmware 136 is external to the platform-side operating system.

Basic Input Output System (BIOS) and Extensible Firmware Interface (EFI) firmware environments are examples of the boot-time firmware 136. Advanced Configuration and Power Interface (ACPI) firmware environment is an example of the run-time firmware 137. In a preferred embodiment, the data processing system 100 is based on an Intel Architecture Environment. A data processing system based on the Intel Architecture Environment comprises semiconductor devices based on Intel Architectures (e.g., IA32, IA64, x86-64, etc) and makes use of at least one of BIOS, ACPI and EFI firmware environments.

The service processor 105 relies on the discovery components 115 (e.g., low-level device drivers) to determine the presence and functionality of the operating system components 135. In this manner, the service processor 105 is capable of tracking status information of the operating system components 135. Such status information is an example of system configuration information (i.e., information influencing the system configuration), of which at least a portion is used during configuration of the platform-side operating system. Additional system configuration information may be received by the system configuration application 125 from the system management user interface 120 (e.g., as entered by a system administrator). It is contemplated that in other embodiments (not shown) of the data processing system 100, the system management user interface 120 may be external to the data processing system 100 (e.g., a remote data processing system). The platform firmware 130 is coupled to the service processor 105, thereby enabling system configuration information to be provided from the service processor 105 to the platform firmware 130.

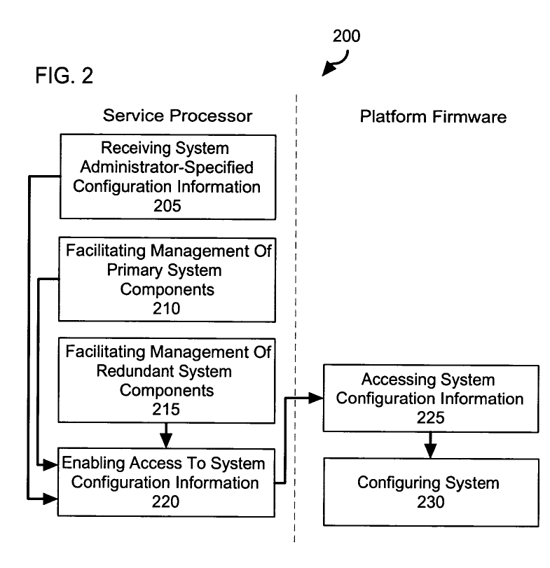

A method 200 in accordance with an embodiment of the disclosures made herein is depicted in FIG. 2. The method 200 is configured for facilitating discovery of system configuration information via a service processor of a data processing system and for facilitating configuration of a platform-side operating system of the data processing system using at least a portion of discovered system configuration information. The system 100 disclosed above and other systems in accordance with embodiments of the disclosures made herein are examples of systems capable of implementing the method 200.

An operation 205 is performed by the service processor for receiving administrator specified configuration information. The operation 205 may be initiated by a system administrator and./or by the service processor. For example, the system administrator may chose to modify a particular portion of the operating system configuration without being solicited to do so by the service processor or the system administrator may be solicited by the service processor to enter information required by the service processor.

An operation 210 is performed by the service processor for facilitating management of primary system components. A primary system component is defined herein to be the system component that is in use during a present platform-side operating system instantiation. Facilitating management of the primary system components enables status information associated with the primary system components to be tracked. So that the platform-side operating system can be beneficially configured, it is advantageous to know whether each primary system component is operating properly during a particular platform-side operating system instantiation and that each primary system component is available for providing corresponding functionality in a subsequent platform-side operating system instantiation (e.g., upon re-boot of the platform-side operating system).

An operation 215 is performed by the service processor for facilitating management of redundant system components. A redundant system component is defined herein to be a system component that is not needed during a given platform-side operating system instantiation. Facilitating management of the redundant system components enables status information associated with the redundant system components to be tracked. So that the platform-side operating system can be beneficially configured, it is advantageous to know whether each redundant system component is available for providing corresponding functionality if a corresponding primary system component fails.

A specific example of a redundant component is a path to an I/O device in a Hyper-Transport path. The Hyper-Transport protocol allows the data processing system to be configured in a manner that specifies the path to particular memory and/or I/O devices. A data processing system with multiple paths that can access a given I/O device, or region of memory, can maintain some of those paths as redundant paths that can be configured to replace other paths if they should fail.

In response to receiving administrator-specified configuration information, facilitating management of primary system components and/or facilitating management of redundant system components, an operation 220 is performed by the service processor for enabling access of system configuration information (e.g., in its entirety or a portion thereof) by the platform firmware. After performing an operation 225 for accessing at least a portion of the system configuration information, an operation 230 is performed by the platform firmware for configuring the platform-side operating system dependent upon at least a portion of the accessed system configuration information.

In this manner, the platform-side operating system is configured based on information that was discovered and analyzed by the service processor prior to the system boot (i.e., being re-booted). This allows the service to track the history of components, and analyze the remains of a previous instantiation of the platform-side operating system to determine if a component should be included in the next boot. The service processor can initiate human interaction (e.g., interact with a system administrator) prior to boot to warn about failing components or, if preferences so dictate, the service processor can automatically remove suspect components.

In an embodiment where the platform firmware includes boot-time firmware, enabling access of the system configuration information by the boot-time firmware includes transmitting at least a portion of system configuration information (e.g., system component status information) for reception by the boot-time firmware via a network-like connection. Examples of such a network-like connection include a connection enabled by hardware control logic that provides an interface utilizing dual access memory with TCP, UDP, and IP protocols and a connection enabled using Ethernet interface approaches. In an embodiment where the platform firmware includes run-time firmware, enabling access of the system configuration information by the run-time firmware includes maintaining at least a portion of the system configuration information (e.g., system component status information) in a persistent data structure (e.g., a persistent memory table) that is accessible by the run-time firmware. Accordingly, access to at least a portion of the status information by the run-time firmware is enabled. It is contemplated herein that a service processor of a data processing system as disclosed herein is capable of transmitting system configuration information and/or maintaining system configuration information in a persistent data structure.

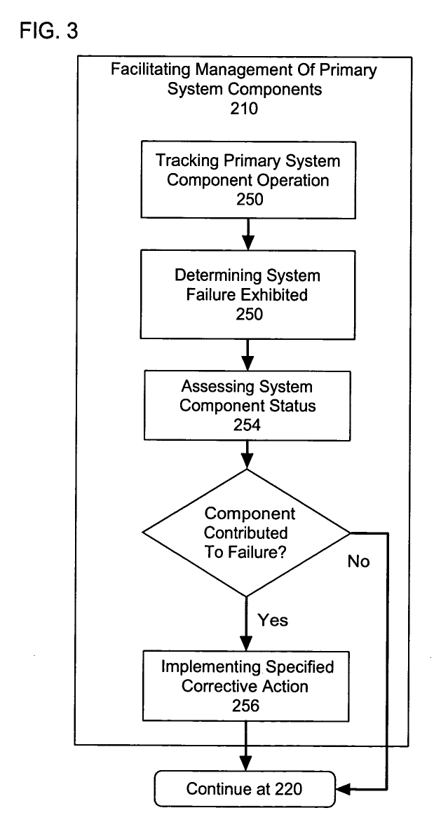

An embodiment of the operation 210 for facilitating management of primary system components is depicted in FIG. 3. As depicted, an operation 250 is performed for tracking operation of the primary system components. Probing device drivers associated with each primary system component and receiving status information of each primary system components from the corresponding device driver is an example of tracking operation of the primary system components. Accordingly, tracking operation of the primary system components provides for tracking of status information associated with the primary system components.

During intended operation of the platform-side operating system, operation of each primary system components is tracked until either the system is shut down or until a platform-side operating system failure is detected. In response to performing an operation 252 for determining that a platform-side operating system failure has been exhibited (e.g., receiving an operating system failure notification), an operation 254 is performed for assessing status of the primary system components. For example, a service processor of the data processing system queries for information available on the system to determine if one of the primary system components was responsible for the failure. If it is determined that a particular primary system components is at fault, an operation 256 is performed for implementing a specified corrective action. An example of such specified corrective actions is to employ administrator-specified preferences to determine if the particular primary system component should be removed or replaced prior to the next boot of the platform-side operating system. If none of the primary system components are at fault, the method continues at an operation 220 for enabling access of system configuration information (including any newly discovered status information) by the platform firmware.

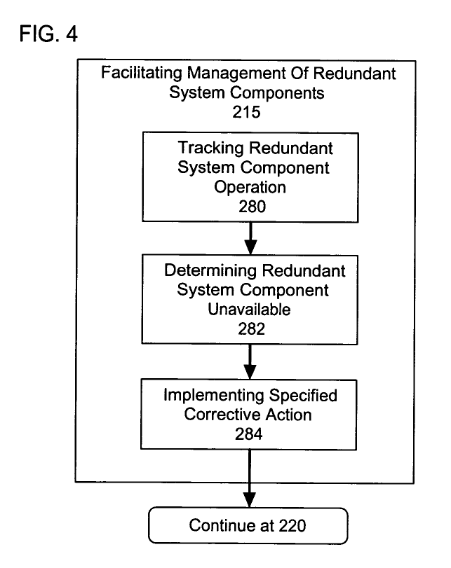

An embodiment of the operation 215 for facilitating management of redundant system components is depicted in FIG. 4. As depicted, an operation 280 is performed for tracking operation of the redundant system components that are idle during a particular platform-side operating system instantiation (e.g., not presently providing redundancy functionality). Probing device drivers associated with each redundant system component and receiving status information of each redundant system components from the corresponding device driver is an example of tracking operation of the redundant system components. Accordingly, tracking operation of the redundant system components provides for tracking of status information associated with the redundant system components.

During intended operation of the platform-side operating system, status information of redundant system components tracked (e.g., periodically via probing). In response to performing an operation 252 for determining that a particular redundant system component is unavailable to provide redundancy functionality (e.g., the redundant system component has been removed or has errors), an operation 284 is performed for implementing a specified corrective action. An example of such specified corrective actions includes warning a system administrator to repair or replace that component for maintaining fail-over capability.

Referring now to computer readable medium in accordance with embodiments of the disclosures made herein, methods as disclosed herein are tangibly embodied by computer readable medium having instructions thereon for carrying out such methods. In one specific example, instructions are provided for carrying out the various operations of the method 100. The instructions may be accessible by the service processor and platform-side operating system from a memory apparatus of the data processing system (e.g. RAM, ROM, virtual memory, hard drive memory, etc), from an apparatus readable by a drive unit of the data processing system (e.g., a diskette, a compact disk, a tape cartridge, etc) or both. Examples of computer readable medium include a compact disk or a hard drive, which has imaged thereon a computer program for carrying out discovery and configuration functionality as disclosed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical, mechanical and electrical changes may be made without departing from the spirit or scope of the invention. For example, functional blocks shown in the figures could be further combined or divided in any manner without departing from the spirit or scope of the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A method for facilitating system management in a data processing system, comprising:
tracking status information of a system component of a platform-side operating system in a data processing system, wherein said tracking is facilitated by a service processor of the data processing system; and
configuring the platform-side operating system dependent at least partially upon said status information, wherein said configuring is facilitated at least partially by platform firmware of data processing system.

2. The method of claim 1 wherein said tracking includes:
probing a device driver associated with the system component; and
receiving said status information from the device driver.

3. The method of claim 1, further comprising:
enabling access of at least a portion of said status information by said platform firmware for enabling said configuring to be facilitated, wherein said enabling access is facilitated by the service processor.

4. The method of claim 3 wherein:
said platform firmware includes boot-time firmware; and
said enabling access includes transmitting at least a portion of said status information at boot-time by the service processor for reception by said boot-time firmware.

5. The method of claim 4 wherein said transmitting includes transmitting over a network connection.

6. The method of claim 3 wherein:
said platform firmware includes run-time firmware; and
said enabling access includes maintaining at least a portion of said status information in a persistent data structure that is accessible by said run-time firmware thereby enabling said run-time firmware to access at least a portion of said status information.

7. The method of claim 1 wherein said tracking includes:
querying a device driver associated with the system component after an adverse operating system condition for determining if the system component contributed to the adverse operating system action and
implementing a specified corrective action in response to a determination that the system component contributed to the adverse operating system condition.

8. The method of claim 1 wherein said tracking includes:
determining that the system component is a redundant system component that is idle during a present operating system instantiation;
monitoring status of the system component during the present operating system instantiation; and
implementing a specified corrective action in response to a determination that the system component is at least temporarily unable to provide intended redundancy functionality.

9. The method of claim 1, further comprising:
receiving user-specified configuration information via a service processor based user interface; and
transmitting at least a portion of said user-specified configuration information by the service processor for reception by said platform firmware;
wherein said configuring is further dependent at least partially upon said user-specified configuration information.

10. A method for facilitating system management in a data processing system, comprising:
tracking status information of a system component of a platform-side operating system in a data processing system; and
enabling access of at least a portion of said status information by platform firmware of the data processing system for enabling the platform-side operating system to be configured dependent at least partially upon said status information;
wherein said tracking and said enabling access are facilitated by a service processor of the data processing system.

11. The method of claim 10 wherein said tracking includes:
probing a device driver associated with the system component; and
receiving said status information from the device driver.

12. The method of claim 10 wherein:
said platform firmware includes boot-time firmware; and
said enabling access includes transmitting at least a portion of said status information at boot-time by the service processor for reception by said boot-time firmware.

13. The method of claim 12 wherein said transmitting includes transmitting over a network connection.

14. The method of claim 10 wherein:
said platform firmware includes run-time firmware; and
said enabling access includes maintaining at least a portion of said status information in a persistent data structure that is accessible by said run-time firmware thereby enabling said run-time firmware to access at least a portion of said status information.

15. The method of claim 10 wherein said tracking includes:
querying a device driver associated with the system component after an adverse operating system condition for determining if the system component contributed to the adverse operating system action and
implementing a specified corrective action in response to a determination that the system component contributed to the adverse operating system condition.

16. The method of claim 10 wherein said tracking includes:
determining that the system component is a redundant system component that is idle during a present operating system instantiation;
monitoring status of the system component during the present operating system instantiation; and
implementing a specified corrective action in response to a determination that the system component is at least temporarily unable to provide intended redundancy functionality.

17. The method of claim 10, further comprising:
receiving user-specified configuration information via a service processor based user interface; and
transmitting at least a portion of said user-specified configuration information by the service processor for reception by said platform firmware;
wherein said configuring is further dependent at least partially upon said user-specified configuration information.

18. A method for facilitating system management in a data processing system, comprising:
accessing status information of a system component of a platform-side operating system in a data processing system; and
configuring the platform-side operating system dependent at least partially upon said status information;
wherein said accessing and at least a portion of said configuring are facilitated by platform firmware of data processing system.

19. The method of claim 18 wherein said accessing is facilitated in response to said status information being transmitted by a service processor of the data processing system for reception by said platform firmware

20. The method of claim 18 wherein:
said platform firmware includes boot-time firmware; and
said accessing includes receiving at least a portion of said status information at boot-time.

21. The method of claim 20 wherein said accessing includes receiving at least a portion of said status information via a network connection.

22. The method of claim 18 wherein:
said platform firmware includes run-time firmware; and
said accessing includes accessing at least a portion of said status information in a persistent data structure maintained at least partially by the service processor and accessible by said run-time firmware.

23. The method of claim 18, further comprising:
receiving user-specified configuration information transmitted by the service processor for reception by the platform firmware, wherein said configuring is further dependent at least partially upon said user-specified configuration information.

24. The method of claim 18, wherein:
said configuring includes implementing a specified corrective action for a particular redundant system component in response to said status information indicating that the particular redundant system component is unavailable to provide intended redundancy functionality.

25. The method of claim 24 wherein the specified corrective action includes at least one of issuing notification of the unavailability of the particular redundant system component and issuing notification to repair or replace that component for maintaining fail-over capability.

26. A computer readable medium, comprising:
instructions processable by at least one of a service processor in a data processing system and platform firmware of a platform-side operating system in the data processing system; and
an apparatus from which said instructions are accessible by at least one of the service processor and said platform firmware;
wherein said instructions being adapted for enabling at least one of the service processor and said platform firmware to facilitate:
tracking status information of a system component of the platform-side operating system, wherein said tracking is facilitated by the service processor; and
configuring the platform-side operating system dependent at least partially upon said status information, wherein said configuring is facilitated at least partially by said platform firmware.

27. The computer readable medium of claim 26 wherein said tracking includes:
probing a device driver associated with the system component; and
receiving said status information from the device driver.

28. The computer readable medium of claim 26 wherein said instructions are further adapted for enabling at least one of the service processor and said platform firmware to facilitate:
enabling access of at least a portion of said status information by said platform firmware for enabling said configuring to be facilitated, wherein said enabling access is facilitated by the service processor.

29. The computer readable medium of claim 28 wherein:
said platform firmware includes boot-time firmware; and
said enabling access includes transmitting at least a portion of said status information at boot-time by the service processor for reception by said boot-time firmware.

30. The computer readable medium of claim 29 wherein said transmitting includes transmitting over a network connection.

31. The computer readable medium of claim 28 wherein:
said platform firmware includes run-time firmware; and
said enabling access includes maintaining at least a portion of said status information in a persistent data structure that is accessible by said run-time firmware thereby enabling said run-time firmware to access at least a portion of said status information.

32. The computer readable medium of claim 26 wherein said tracking includes:
querying a device driver associated with the system component after an adverse operating system condition for determining if the system component contributed to the adverse operating system action and
implementing a specified corrective action in response to a determination that the system component contributed to the adverse operating system condition.

33. The computer readable medium of claim 26 wherein said tracking includes:
determining that the system component is a redundant system component that is idle during a present operating system instantiation;
monitoring status of the system component during the present operating system instantiation; and
implementing a specified corrective action in response to a determination that the system component is at least temporarily unable to provide intended redundancy functionality.

34. The computer readable medium of claim 26 wherein said instructions are further adapted for enabling at least one of the service processor and said platform firmware to facilitate:
receiving user-specified configuration information via a service processor based user interface; and
transmitting at least a portion of said user-specified configuration information by the service processor for reception by said platform firmware;
wherein said configuring is further dependent at least partially upon said user-specified configuration information.

35. A computer readable medium, comprising:
instructions processable by at least one of a service processor in a data processing system and platform firmware of a platform-side operating system in the data processing system; and
an apparatus from which said instructions are accessible by at least one of the service processor and said platform firmware;
wherein said instructions being adapted for enabling at least one of the service processor and said platform firmware to facilitate:
tracking status information of a system component of the platform-side operating system; and
enabling access of at least a portion of said status information by said platform firmware for enabling the platform-side operating system to be configured dependent at least partially upon said status information;
wherein said tracking and said enabling access are facilitated by the service processor of the data processing system.

36. The computer readable medium of claim 35 wherein said tracking includes:
probing a device driver associated with the system component; and
receiving said status information from the device driver.

37. The computer readable medium of claim 35 wherein:
said platform firmware includes boot-time firmware; and
said enabling access includes transmitting at least a portion of said status information at boot-time by the service processor for reception by said boot-time firmware.

38. The computer readable medium of claim 37 wherein said transmitting includes transmitting over a network connection.

39. The computer readable medium of claim 35 wherein:
said platform firmware includes run-time firmware; and
said enabling access includes maintaining at least a portion of said status information in a persistent data structure that is accessible by said run-time firmware thereby enabling said run-time firmware to access at least a portion of said status information.

40. The computer readable medium of claim 35 wherein said tracking includes:
querying a device driver associated with the system component after an adverse operating system condition for determining if the system component contributed to the adverse operating system action and
implementing a specified corrective action in response to a determination that the system component contributed to the adverse operating system condition.

41. The computer readable medium of claim 35 wherein said tracking includes:
determining that the system component is a redundant system component that is idle during a present operating system instantiation;
monitoring status of the system component during the present operating system instantiation; and
implementing a specified corrective action in response to a determination that the system component is at least temporarily unable to provide intended redundancy functionality.

42. The computer readable medium of claim 35 wherein said instructions are further adapted for enabling at least one of the service processor and said platform firmware to facilitate:
receiving user-specified configuration information via a service processor based user interface; and
transmitting at least a portion of said user-specified configuration information by the service processor for reception by said platform firmware;
wherein said configuring is further dependent at least partially upon said user-specified configuration information.

43. A computer readable medium, comprising:
instructions processable by at least one of a service processor in a data processing system and platform firmware of a platform-side operating system in the data processing system; and
an apparatus from which said instructions are accessible by at least one of the service processor and said platform firmware;
wherein said instructions being adapted for enabling at least one of the service processor and said platform firmware to facilitate:
accessing status information of a system component of the platform-side operating system; and
configuring the platform-side operating system dependent at least partially upon said status information;
wherein said accessing and at least a portion of said configuring are facilitated by platform firmware of data processing system.

44. The computer readable medium of claim 43 wherein said accessing is facilitated in response to said status information being transmitted by a service processor of the data processing system for reception by said platform firmware

45. The computer readable medium of claim 43 wherein:
said platform firmware includes boot-time firmware; and
said accessing includes receiving at least a portion of said status information at boot-time.

46. The computer readable medium of claim 45 wherein said accessing includes receiving at least a portion of said status information via a network connection.

47. The computer readable medium of claim 43 wherein:
said platform firmware includes run-time firmware; and
said accessing includes accessing at least a portion of said status information in a persistent data structure maintained at least partially by the service processor and accessible by said run-time firmware.

48. The computer readable medium of claim 43 wherein said instructions are further adapted for enabling at least one of the service processor and said platform firmware to facilitate:
receiving user-specified configuration information transmitted by the service processor for reception by the platform firmware, wherein said configuring is further dependent at least partially upon said user-specified configuration information.

49. The method of claim 43, wherein:
said configuring includes implementing a specified corrective action for a particular redundant system component in response to said status information indicating that the particular redundant system component is unavailable to provide intended redundancy functionality.

50. The method of claim 49 wherein the specified corrective action includes at least one of issuing notification of the unavailability of the particular redundant system component and issuing notification to repair or replace that component for maintaining fail-over capability.
